(19) United States
(12) Patent Application Publication
(10) Pub. No.: US 2013/0122982 A1
(43) Pub. Date: May 16, 2013

(54) METHOD, CIRCUIT, DEVICE, SYSTEM, AND CORRESPONDING COMPUTER READABLE CODE FOR FACILITATING COMMUNICATION WITH AND AMONG INTERACTIVE DEVICES

(71) Applicants: Ilan Laor, Casearea (IL); Dan Kogan, Ein Hod (IL)

(72) Inventors: Ilan Laor, Casearea (IL); Dan Kogan, Ein Hod (IL)

(73) Assignee: TOY TOY TOY LTD., Caesarea (IL)

(21) Appl. No.: 13/641,911

(22) PCT Filed: Apr. 19, 2011
(86) PCT No.: PCT/IB11/51702

§ 371 Date: Jan. 28, 2013

Related U.S. Application Data
(60) Provisional application No. 61/325,368, filed on Apr. 19, 2010.
(60) Provisional application No. 61/442,245, filed on Feb. 13, 2011.

(51) Int. Cl. G06F 13/10; A63F 9/24

(52) U.S. Cl. CPC G06F 13/10; A63F 9/24
USPC 463/16; 463/40; 463/35

(57) ABSTRACT

Disclosed, is to a method, circuit, device, system, and corresponding computer readable code for facilitating communication with and among one or more interactive devices. An interactive device, in accordance with the present invention, comprises an acoustic sensor to sense one or more acoustic signals, a signal recognition circuitry to recognize a sensed signal in a signals reference and correlation table and to correlate recognized signal to one or more corresponding commands, and a behavior logic module to select one or more responses from a command to response correlation logical map wherein the one or more responses are selected based on the correlated one or more commands and one or more secondary factors.

### FIELD OF THE INVENTION

The present invention generally relates to the field of interactive toys and devices. More specifically, the present invention relates to a method, circuit, device, system, and corresponding computer readable code for facilitating communication with and among one or more interactive devices.

### BACKGROUND

As some physical toy sales decline, while video games are seeing an increase in sales, a current trend in children gaming is the tying of virtual environments to real-world merchandise. These kinds of toys, blend the comfort and charm of physical toys with the addictive challenges of online role-playing games and interaction. The combination has proven as habit forming as the Tamagotchi phenomenon.

Toy products now enable the registration of a given toy on a web/application server, its correlation to a lookalike avatar, and the interaction, playing and caretaking of the toy's virtual avatar by the user accessing an application running on the web/application server through a computing platform's web browser.

Still remains a need in the field of interactive toys and devices, for a method, circuit, device, system, and corresponding computer readable code for facilitating communication with and among one or more interactive devices; wherein toys, or other interactive devices, may receive and respond to signal based commands embedded into: internet websites, TV broadcasts, DVDs, other interactive toys or devices, and/or any other media content source or device. Such interactive toys or devices may also be adapted to recognize and interact with environmental sounds, such as human voices, using sound recognition techniques and modules, and/or to also base their responses on certain ‘moods’ or specific content types and environments into which the signal based commands were embedded.

### SUMMARY OF THE INVENTION

The present invention is a method, circuit, device, system, and corresponding computer readable code for facilitating communication with and among one or more interactive devices such as dolls. According to some embodiments of the present invention, an interactive device may comprise a Central Processing Unit (CPU), a Non-Volatile Memory (NVM), an Input Signal Sensor (ISS), a Signal Preprocessing and Processing Circuitry (SPPC)a Signal Recognition Circuitry (SRC),a Behavior Logic Module (BLM), an Output Components Logic (OCL), a Wire Connection Interface (WCI) and/or one or more output components.

According to some embodiments of the present invention, a signal sensed by the ISS may be treated by the SPPC, transmitted to and recognized by the SRC as corresponding to one or more commands. Recognized commands may be transmitted to, and correlated by, the BLM to one or more corresponding response(s), stored on the device's NVM. The correlated response(s) may be used by the OCL to generate one or more signals for one or more of the interactive device's output components. The WCI may be used for connecting the interactive device to a computerized host device. Connection to the host device may, for example, be used for initializing, registering and/or updating the interactive device, its software/firmware components and/or the data stored on its NVM.

According to some embodiments of the present invention, the ISS may take the form of a radio frequency receiver, a light sensor (e.g. an infrared receiver), an acoustic sensor (e.g. a microphone) and/or any signal sensing means known today or to be devised in the future. Furthermore, it is made clear that although some of the teachings described in the present invention may relate to acoustic signals and to the processing and utilization of such; corresponding, known in the art, signal processing components, devices, circuits and methods, for other signal types (e.g. optical, electromagnetic) may be used to achieve substantially similar results—all of which fall within the true spirit of the present invention.

According to some exemplary embodiments, wherein an acoustic sensor is used, the sensed signal(s) may be one or more acoustic signals in some range of audible and/or inaudible frequencies. The ISS may convert the acoustic signals into corresponding electrical signals; the SPPC may extract specific frequency components from the signals; the SRC may lookup/correlate the extracted signals to specific commands and may signal to the BLM which commands were detected.

According to some embodiments of the present invention, the BLM may select the one or more responses to be outputted by the interactive device, wherein the selected response(s) may be at least partially based on commands recognized by the SRC. According to some embodiments, a logical map may be used for correlating between each detected command, or detected set of commands, and one or more corresponding responses for the interactive device(s) to perform/execute/output. The response may be in the form of an acoustic, an optical, a physical or an electromagnetic output, generated by the device's OCL and outputted by one or more of device's output components.

A response, in accordance with some embodiments of the present invention, may take the form of (1) an output (e.g. sound, movement, light) being made/executed by the device; (2) a ‘mood’ in which the device is operating being changed; (3) a download of updates or responses/response-package(s) being initiated; and/or (4) a certain device becoming a device dominant over other devices (e.g. it will be the first to react to a signal sensed by two or more devices, other devices sensing the signal may then follow by responding to the dominant device's own response).

According to some embodiments of the present invention, a response outputted by a given interactive device may be sensed by other, substantially similar, interactive devices, and may thus trigger further responses by these devices. Accordingly, a response of a given interactive device, for example to a command originating at an internet website, may set off a conversation (i.e. an initial response and one or more responses to the initial response and to the following responses) between two or more interactive devices that are able to sense each other's output signals.

According to some embodiments of the present invention, the interactive device may be initiated and/or registered at a dedicated web/application server. According to some embodiments, each interactive device may comprise a unique code that may, for example, be printed on its label and/or written to its NVM. Using the unique code, each interactive device may be initially activated and/or registered at a dedicated web-server/networked-server. Registered devices may then be specifically addressed by the dedicated website, by other websites/interactive-devices, and/or by any other acoustic signal emitting source to which the registration details/code have been communicated, by outputting acoustic signal based commands to which only specific interactive-devices or specific group(s) of interactive-devices will react.

According to some embodiments of the present invention, different response packages/sets may be downloaded to the interactive device. According to some embodiments, acoustic signals sensed by device, and corresponding commands, may contain a reference to a specific response package. Accordingly, two given, else wise similar, command numbers may each contain a different response package number/code and may thus trigger different responses associated with the specific source and or content from which they originated.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a schematic, exemplary interactive device, in accordance with some embodiments of the present invention;

FIG. 2A shows an exemplary interactive device Input Signal Sensor (ISS), in accordance with some embodiments of the present invention;

FIG. 2B shows an exemplary interactive device Input Signal Sensor (ISS) which is further adapted to sense environmental sounds, in accordance with some embodiments of the present invention;

FIG. 3 shows an exemplary Signal Preprocessing and Processing Circuitry (SPPC) , in accordance with some embodiments of the present invention;

FIG. 4A shows an exemplary Signal Recognition Circuitry (SRC), in accordance with some embodiments of the present invention;

FIG. 4B shows an exemplary Signal Recognition Circuitry (SRC) which further comprises a sound recognition module adapted to recognize environmental sounds detected, in accordance with some embodiments of the present invention;

FIG. 5 shows an exemplary Behavior Logic Module (BLM), in accordance with some embodiments of the present invention;

FIG. 6 shows an exemplary Output Component Logic (OCL), in accordance with some embodiments of the present invention;

FIG. 7 shows an exemplary configuration of an interactive device connected/interfaced to a host computer by a wire, using the device's Wire Connection Interface (WCI) and the host computer's Interactive Device Interface Circuitry (e.g. USB port), in accordance with some embodiments of the present invention;

FIG. 8 shows an exemplary configuration of an interactive device communicating with a Dedicated Web/Application Server through a host computer, using their acoustic input and output components, in accordance with some embodiments of the present invention;

FIG. 9 shows an exemplary configuration of an interactive device is adapted to receive and respond to acoustic messages/signals from an Affiliate Web/Application Server, in accordance with some embodiments of the present invention;

FIG. 10 shows an exemplary reference table that may be used to select responses corresponding to different response packages/sets, in accordance with some embodiments of the present invention;

FIG. 11A shows an exemplary configuration wherein an interactive device is adapted to download an affiliate response package, in accordance with some embodiments of the present invention; and

FIG. 11B shows an exemplary configuration wherein an interactive device is adapted to output a response based on a downloaded affiliate response package, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a method, circuit, device, system, and corresponding computer readable code for facilitating communication with and among one or more interactive devices such as dolls. According to some embodiments of the present invention, an interactive device may comprise a Central Processing Unit (CPU), a Non-Volatile Memory (NVM), an Input Signal Sensor (ISS), a Signal Preprocessing and Processing Circuitry (SPPC)a Signal Recognition Circuitry (SRC),a Behavior Logic Module (BLM), an Output Components Logic (OCL), a Wire Connection Interface (WCI) and/or one or more output components.

According to some embodiments of the present invention, a signal sensed by the ISS may be treated by the SPPC, transmitted to and recognized by the SRC as corresponding to one or more commands. Recognized commands may be transmitted to, and correlated by, the BLM to one or more corresponding response(s), stored on the device's NVM. The correlated response(s) may be used by the OCL to generate one or more signals for one or more of the interactive device's output components. The WCI may be used for connecting the interactive device to a computerized host device. Connection to the host device may, for example, be used for initializing, registering and/or updating the interactive device, its software/firmware components and/or the data stored on its NVM.

According to some embodiments of the present invention, the ISS may take the form of a radio frequency receiver, a light sensor (e.g. an infrared receiver), an acoustic sensor (e.g. a microphone) and/or any signal sensing means known today or to be devised in the future. Furthermore, it is made clear that although some of the teachings described in the present invention may relate to acoustic signals and to the processing and utilization of such; corresponding, known in the art, signal processing components, devices, circuits and methods, for other signal types (e.g. optical, electromagnetic) may be used to achieve substantially similar results—all of which fall within the true spirit of the present invention.

According to some exemplary embodiments, wherein an acoustic sensor is used, the sensed signal(s) may be one or more acoustic signals in some range of audible and/or inaudible frequencies. The ISS may convert the acoustic signals into corresponding electrical signals; the SPPC may extract specific frequency components from the signals; the SRC may lookup/correlate the extracted signals to specific commands and may signal to the BLM which commands were detected.

According to some embodiments of the present invention, the BLM may select the one or more responses to be outputted by the interactive device, wherein the selected response(s) may be at least partially based on commands recognized by the SRC. According to some embodiments, a logical map may be used for correlating between each detected command, or detected set of commands, and one or more corresponding responses for the interactive device(s) to perform/execute/output. The response may be in the form of an acoustic, an optical, a physical or an electromagnetic output, generated by the device's OCL and outputted by one or more of device's output components.

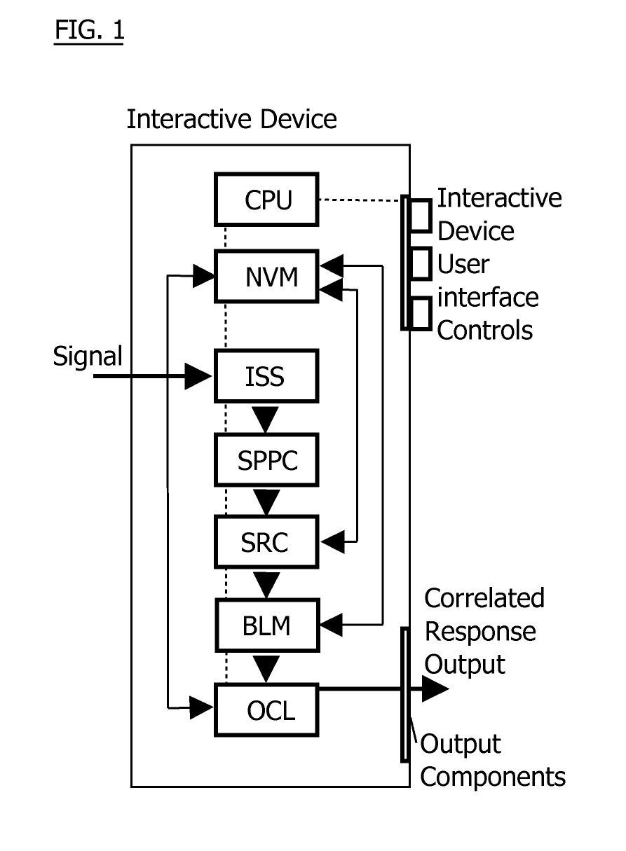

In FIG. 1 there is shown, an interactive device in accordance with some embodiments of the present invention. A sensed signal may be processed by the device and correlated to one or more corresponding responses. Response(s) correlated to a given signal, or a set of signals may be outputted by the device. According to some embodiments, the interactive device may further comprise one or more user interface controls that may be used by the device user to trigger one or more responses. By engaging specific controls, or specific combinations of controls, the user may be able to select certain responses or response types.

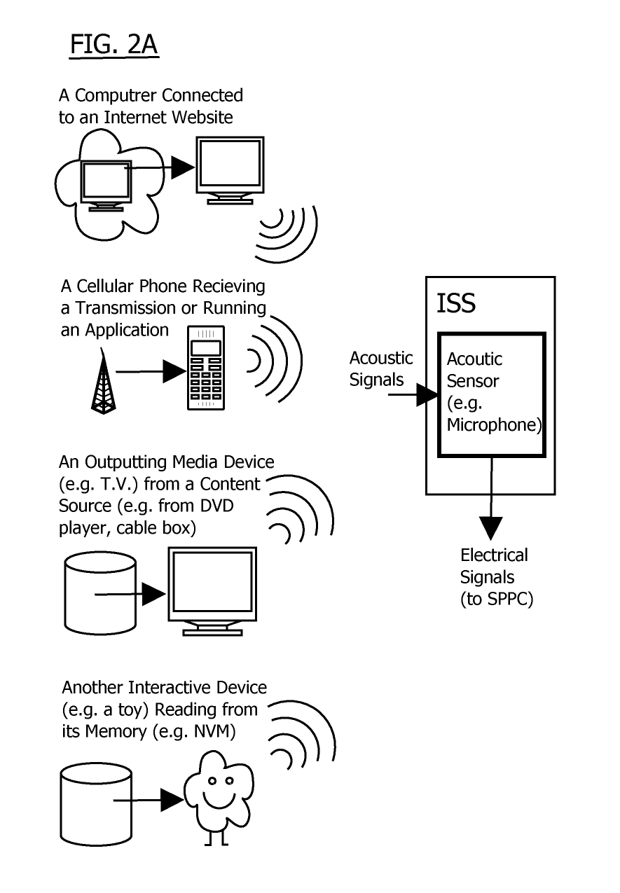

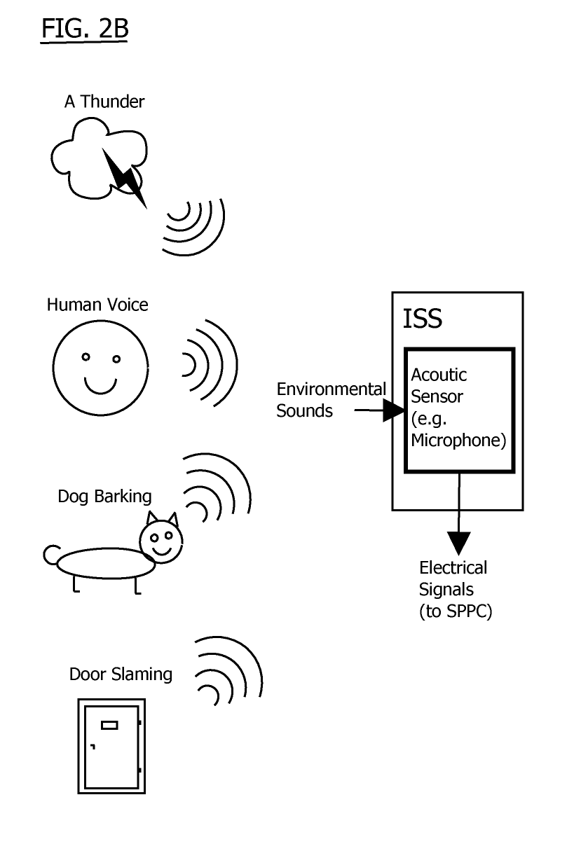

In FIG. 2A there is shown an interactive device Input Signal Sensor (ISS), in accordance with some embodiments of the present invention. The ISS may comprise an acoustic sensor (e.g. microphone) adapted to sense acoustic signals generated by various electronic devices such as, but in no way limited to, computerized devices, cellular phones, media devices (e.g. TV, Radio) and/or other, substantially similar, interactive devices. The source/origin of the signal may be: data/content stored on a networked server (e.g. web-server) which is being downloaded/streamed/rendered/viewed by a networked computerized device, data/content being transmitted/broadcasted to a receiving electronic/computerized device, and/or data/content stored on a physical storage device (e.g. NVM, Magnetic Memory, CD/DVD) read by an electronic/computerized device. The signal may be individually stored and/or communicated, or may be embedded into additional data/content of a similar or different type. The ISS acoustic sensor may transform the sensed acoustic signals into matching electrical signals prior to transmitting them for further processing.

In FIG. 2B there is shown, in accordance with some embodiments of the present invention, an interactive device Input Signal Sensor (ISS) which is further adapted to sense environmental sounds. Environmental sounds may take the form of human voice, animals' voices, object created sounds (e.g. door slamming, object falling), natural phenomena based sounds (e.g. thunder rolling, wind blowing) and/or sounds produced by manmade instruments (e.g. bell, whistle, musical instruments). According to some embodiments, environmental sounds may further include sounds produced by electronic/computerized devices, which sounds do not include acoustic signals, and may not be intentionally directed to cause a response of the interactive device.

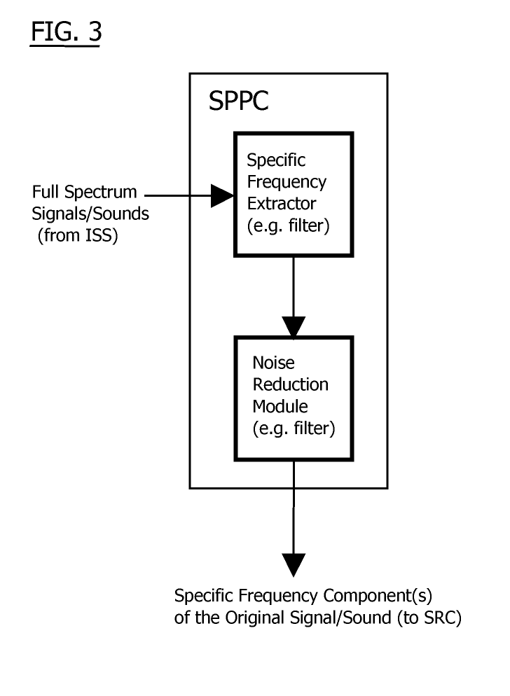

In FIG. 3 there is shown, in accordance with some embodiments of the present invention, a Signal Preprocessing and Processing Circuitry (SPPC). The SPPC may be adapted to extract specific frequency component(s)/range(s), audible and/or inaudible by the human ear, to reduce the noise accompanying the signal and increase the signal to noise ratio and/or to utilize any known in the art signal preprocessing/processing technique that may improve the ability to later recognize the command/code embedded into the signal.

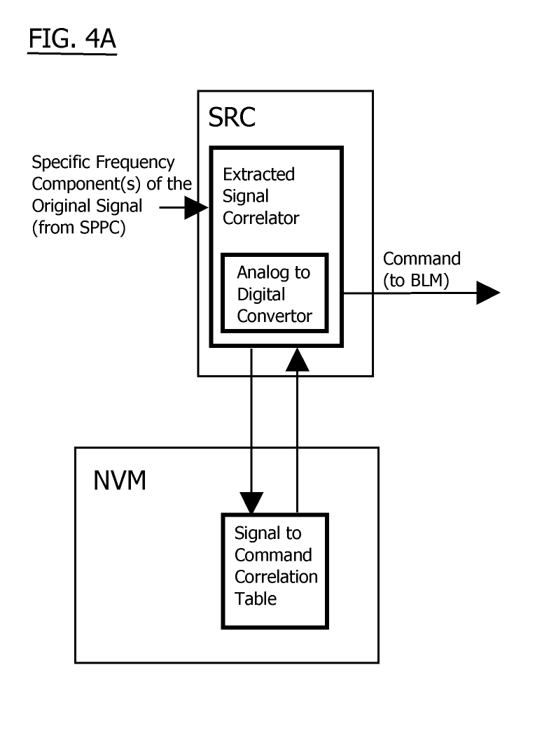

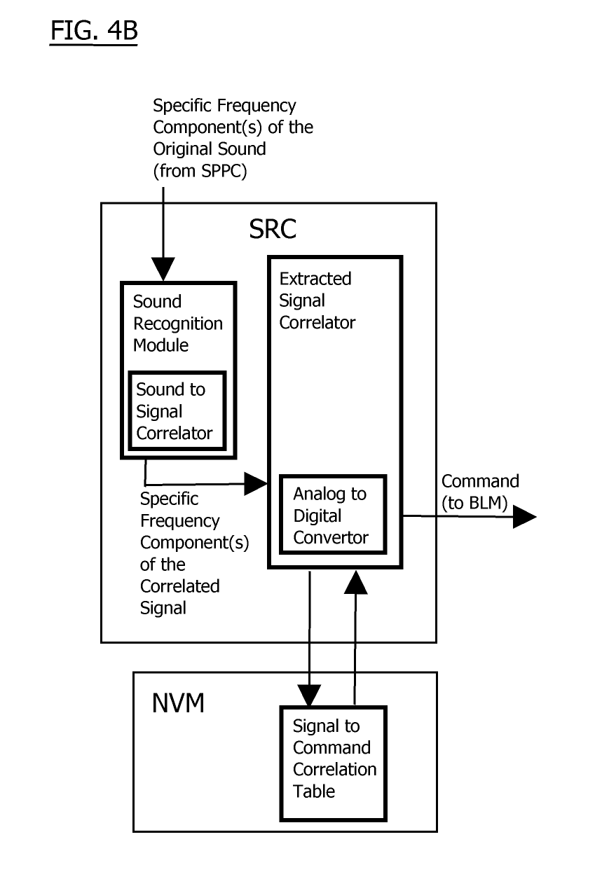

In FIG. 4A there is shown, in accordance with some embodiments of the present invention, a Signal Recognition Circuitry (SRC). The SRC may be adapted to convert the analog processed signal received from the SPPC to a digital signal and to repeatedly sample the converted signal, looking for signal segments representing commands known to it. According to some embodiments, the SRC may reference a signal to command correlation table stored on the interactive device's NVM, searching for signals matching those it has sampled. Upon matching a sampled signal segment to a signal segment in the table, the corresponding command may be read from the NVM and transmitted to the BLM.

A signal segment corresponding to a command, in accordance with some exemplary embodiments of the present invention, may take the form a temporal frame made of a set of one or more temporal sub sections. According to one exemplary embodiment, a sub section in which substantially no acoustic sound/signal is present may correspond to a binary value ‘0’ whereas a sub section in which an acoustic sound/signal is present may correspond to a binary value ‘1’. An entire temporal frame may accordingly represent a number (e.g. binary 00000111 i.e. 7 in decimal base) through which a certain corresponding command, or a certain corresponding set of commands, may be referenced. According to further embodiments, temporal sub sections representing different values may, additionally or alternatively, be differentiated by the strength, pitch, frequency and/or any other character of their acoustic sound/signal. Furthermore, it is made clear that, embodiments of the present invention relating to acoustic signals and the encoding and processing of acoustic signals, may utilize any form or technology of data encoding onto an acoustic signal and the processing of such signals, known today or to be devised in the future.

In FIG. 4B there is shown, in accordance with some embodiments of the present invention, a Signal Recognition Circuitry (SRC) which further comprises a sound recognition module adapted to recognize environmental sounds detected by the ISS. Recognized environmental sounds may be correlated to analogous signals and then to commands corresponding to these signals. Alternatively, some or all of the recognized sounds may be directly correlated to corresponding commands (e.g. by referencing a recognized-sounds/recognized-sound-patterns to command correlation table stored on the interactive device NVM).

According to some embodiments, the sound recognition module may be further adapted to utilize a learning algorithm, wherein data related to user feedback (e.g. correct/incorrect response) to the interactive device's responses is used to better recognize, interpret and/or ‘understand’ certain repeating environmental sounds or sound types, for example a certain device user's voice. According to some embodiments, the user feedback may be entered by the user interacting with the interactive device's user interface controls, through input means of an interfaced host device, and/or through a user-interface of a website running on a web server networked with the interactive device or to a host that the interactive device is connected to/networked with.

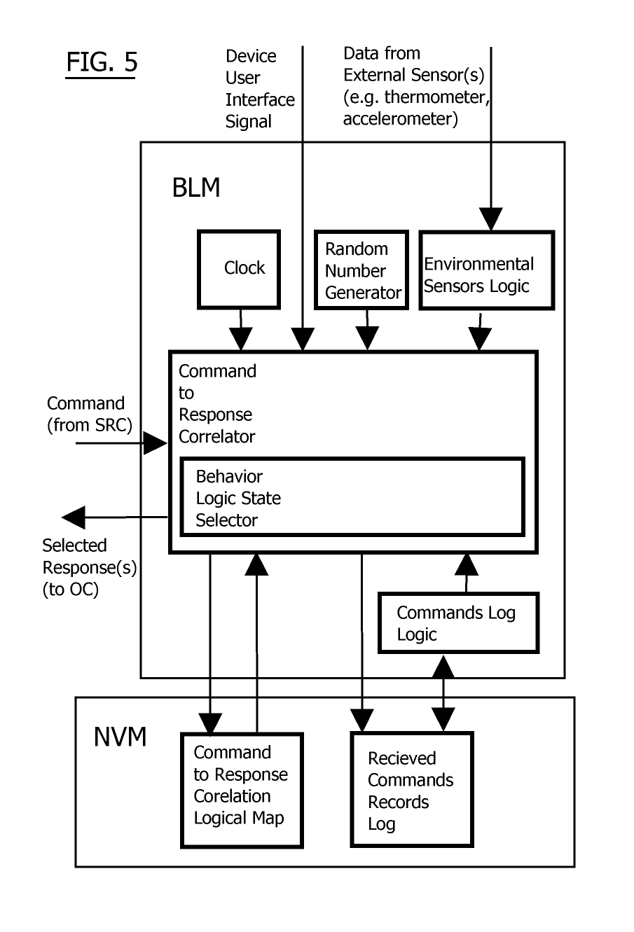

In FIG. 5 there is shown, in accordance with some embodiments of the present invention, a Behavior Logic Module (BLM). The BLM may comprise a command to response correlator adapted to select the response(s) to be outputted by the interactive device by referencing a command to response correlation logical map. The command to response correlation logical map may associate: (1) acoustic-signal and/or environmental-sound based commands; (2) internal device-generated parameters; (3) environmental parameters sensed by the device; (4) direct or indirect (e.g. through an interfaced host) user interactions with the device; and/or (5) any combination of these, to one or more respective responses. Furthermore, the command to response correlation logical map may be dynamic and may change its responses and/or the logic of how responses are correlated to (e.g. by downloading updates to existing responses, and/or downloading new responses or response packages/sets). Changes to the command to response correlation logical map may be triggered by: acoustic signal based commands, internal device-generated parameters, environmental parameters sensed by the device, direct or indirect (e.g. through an interfaced host) user interactions with the device and/or any combination of these.

A response, in accordance with some embodiments of the present invention, may take the form of (1) an output (e.g. sound, movement, light) being made/executed by the device; (2) a ‘mood’ in which the device is operating being changed; (3) a download of updates or responses/response-package(s) being initiated; and/or (4) a certain device becoming a device dominant over other devices (e.g. it will be the first to react to a signal sensed by two or more devices, other devices sensing the signal may then follow by responding to the dominant device's own response).

According to some embodiments of the present invention, the interactive devices may operate in one or more of the following exemplary modes: A first mode wherein a received command or a user interaction with the device controls causes only that same device to output a response; a second mode wherein a received command or a user interaction with the device controls causes that device (e.g. the dominant device if the command was received by more than one device) to initiate a ‘conversation’ with other devices in its vicinity (e.g. dominant device tells a joke and the other devices start laughing); and or a third mode wherein a received command or a user interaction with the device controls causes that device, and all devices in its vicinity to harmonically respond (e.g. sing together). According to further embodiments, the interactive device may also operate in a sleep mode activated by its internal clock (e.g. a certain time passed from last command detection, a certain time of the day) or by a user interaction with the device controls. In sleep mode the device may selectively respond to only certain commands or may not respond at all. According to further embodiments, prior to registration of the device it may only output some preprogrammed responses (e.g. ‘please register me’).

According to some embodiments, the BLM may be adapted to operate according to one or more behavior logic states/modes, wherein each of the one or more states may correspond to a “mood” of the interactive device. The device's “mood” may affect the response selected by the BLM (e.g. a similar command triggering a cheering response when the device is in a ‘happy’ mood and a complaining response when the device is in an ‘anxious’ mood). The BLM's transition between behavior logic states/modes may be triggered by one or more of the following: (1) a corresponding command being detected; (2) a corresponding sequence(s) of commands being detected; (3) an internal clock based transition is triggered;(4) a device-environment (e.g. movement of the device, temperature measured by the device, light amount measured by the device, pressure measured by the device etc.) based transition is triggered; and/or (5) a random or pseudo random number generator based transition is triggered.

According to some embodiments, the BLM may be adapted to keep a log (e.g. stored on the interactive device's NVM) of detected commands. A certain pattern of previously logged commands may affect the device's response. For example, if a similar command (i.e. a similar web content sending a similar acoustic signal which is interpreted as a similar command) is detected by the device and a reference of the log shows it has already been detected 3 times by the device, the device's response may change from a ‘cheering’ response to a ‘boring’ response. Furthermore, the log may be used to teach content providers (e.g. advertisers) of the device's, and thus its user's, habits and preferences.

According to some embodiments of the present invention, responses to be outputted by the interactive device may be selected based on one or more of the following: (1) a correlation of one or more commands to a specific response or specific combination of responses; (2) a correlation of one or more commands to a set of possible responses, wherein a specific response or specific combination of responses is randomly or pseudo randomly selected; (3) a correlation of one or more commands to a set of possible responses, wherein a specific response or specific combination of responses is selected based on a “mood” which the interactive device is in—a behavior logic state/mode which the BLM is in; (4) a correlation of one or more commands to a set of possible responses, wherein a specific response or specific combination of responses is selected based on “memories” which the interactive device possesses—a certain appearance of previously detected commands logged by the BLM; (5) a correlation of one or more commands to a set of possible responses, wherein a specific response or specific combination of responses is selected based on a choice made by the interactive device user/owner , and/or the nature of previous response selections made by the interactive device user; (6) a correlation of one or more commands to a set of possible responses, wherein a specific response or specific combination of responses is selected based on the temporal characteristics of the commands/events/messages/inputs detected (e.g. time/date when detected); (7) a correlation of one or more device-environment related parameters, such as, but in no way limited to, those relating to: movement of the device, temperature measured by the device, light amount measured by the device, pressure measured by the device, geographic location determined by the device etc. to a specific response or specific combination of responses; and/or (8) a correlation of one or more parameters internally generated by the interactive device, such as, but in no way limited to, internal clock based temporal parameters and/or values generated by an internal random or pseudo random number generator.

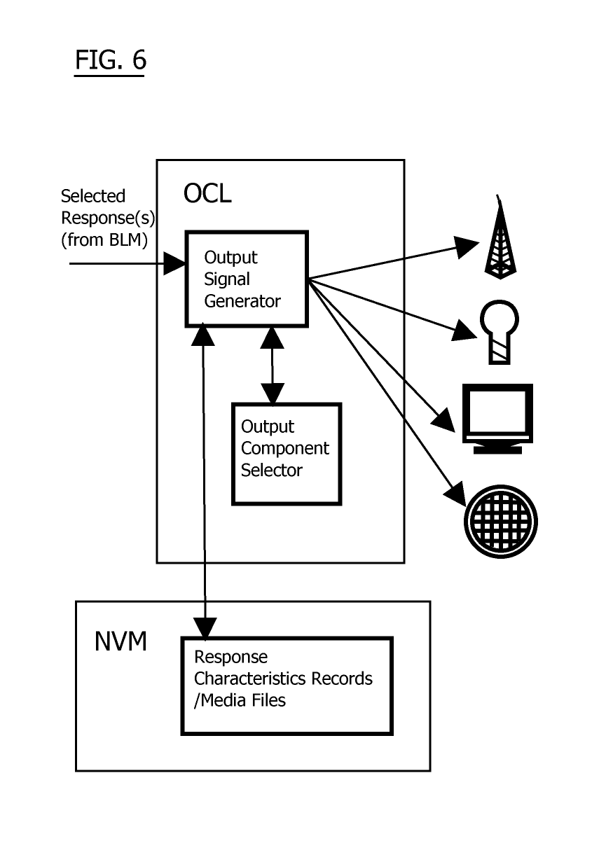

In FIG. 6 there is shown, in accordance with some embodiments of the present invention, an Output Component Logic (OCL). The OCL may receive from the BLM the response(s) to be outputted. The OCL may comprise an Output Signal Generator that Based on the details of a given received response may use an Output Component Selector to select one or more respective output component(s) through which the response will be outputted. The Output Signal Generator may reference the interactive device NVM and access media file(s) and/or other response characteristics records/data to be outputted by the selected device's output component(s).

According to some embodiments of the present invention, a response outputted by a given interactive device may be sensed by other, substantially similar, interactive devices, and may thus trigger further responses by these devices. Accordingly, a response of a given interactive device, for example to a command originating at an internet website, may set off a conversation (i.e. an initial response and one or more responses to the initial response and to the following responses) between two or more interactive devices that are able to sense each other's output signals.

According to some embodiments of the present invention, the interactive device may be initiated and/or registered at a dedicated web/application server. According to some embodiments, each interactive device may comprise a unique code that may, for example, be printed on its label and/or written to its NVM. Using the unique code, each interactive device may be initially activated and/or registered at a dedicated web-server/networked-server. Registered devices may then be specifically addressed by the dedicated website, by other websites/interactive-devices, and/or by any other acoustic signal emitting source to which the registration details/code have been communicated, by outputting acoustic signal based commands to which only specific interactive-devices or specific group(s) of interactive-devices will react.

According to some embodiments, the dedicated website, and/or non-dedicated websites, may be adapted to interactively communicate with the interactive device, using a browsing computing-platform's input (e.g. microphone) and output (e.g. speaker) modules to output and input commands to and from the interactive device. Alternatively, the interactive device's Wire Connection Interface (WCI) may be used to connect the device to the browsing computing-platform, and the website may present a graphical user interface to the device's user on the hosting computing-platform's screen. According to some embodiments, the interactive device's responses, its behavior logic states/modes, and/or the details of its responses and/or logic states/modes may be automatically or selectively updated through the dedicated website.

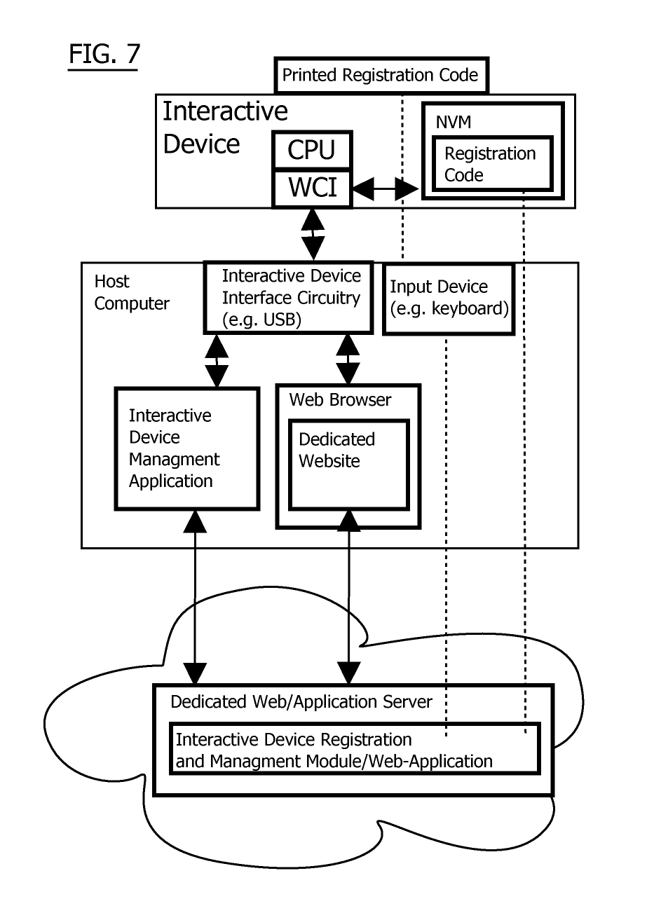

In FIG. 7 there is shown, in accordance with some embodiments of the present invention, an interactive device connected/interfaced to a host computer by a wire, using the device's Wire Connection Interface (WCI) and the host computer's Interactive Device Interface Circuitry (e.g. USB port). As part of an initiation/registration process of the interactive device, the device's registration/serial code may be read from the device's NVM, and communicated through the host computer to the Dedicated Web/Application Server (e.g. using the host computer web-browser and/or an Interactive Device Management Application installed on the host computer). The interactive device user may use one or more of the host computer input devices/components (e.g. keyboard) to feed a Printed Registration Code attached to, or printed onto, the interactive device to the host computer. The user fed code may be communicated by the host computer (e.g. using its web-browser or an installed Interactive Device Management Application) to the Dedicated Web/Application Server. The Dedicated Web/Application Server may comprise an Interactive Device Registration and Management Module adapted to compare between the NVM read code and the user entered code as part of the device registration. A positive comparison may be needed for the Dedicated Web/Application Server to register the interactive device.

According to some embodiments of the present invention, the interactive device user may register one or more interactive devices. As part of registration, or at a later interaction with the dedicated server, the user may select or change an avatar for its interactive device. The selected avatar characteristics/profile may be downloaded to the interactive device and may change/affect the responses to be outputted, and/or the logic by which the responses to be outputted are selected, by the interactive device. Furthermore, the ability to change a given interactive device's avatar may allow for the user to enjoy various differently characterized and reacting devices on a single device hardware platform. According to some embodiments, the dedicated server may be further adapted to receive from the device user (at registration or at a later stage) additional data such as, but in no way limited to, data relating to the device user's age, gender, preferred language, geographical location etc., which data may further affect the interactive device's responses to identified commands and/or better match them to the user's profile/preferences.

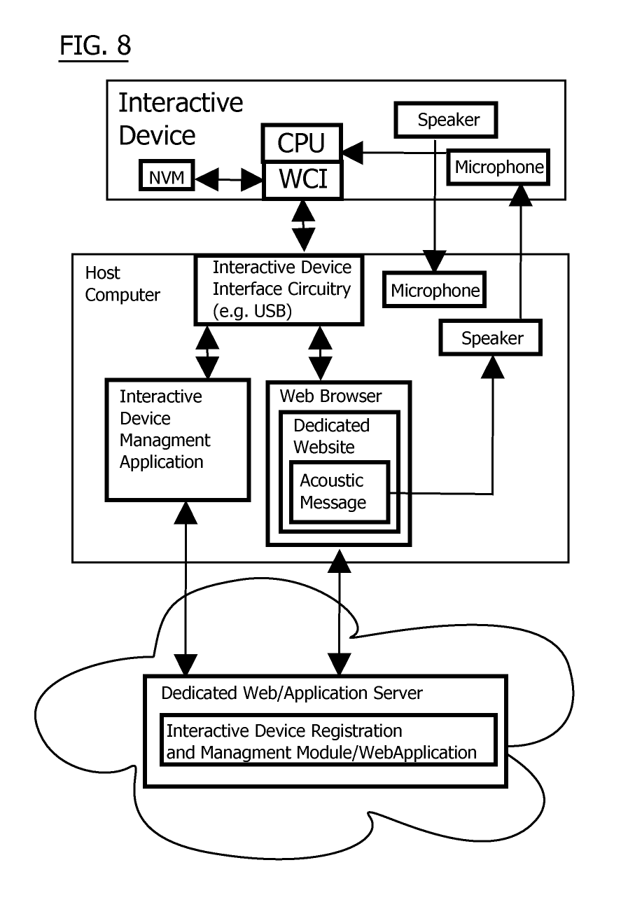

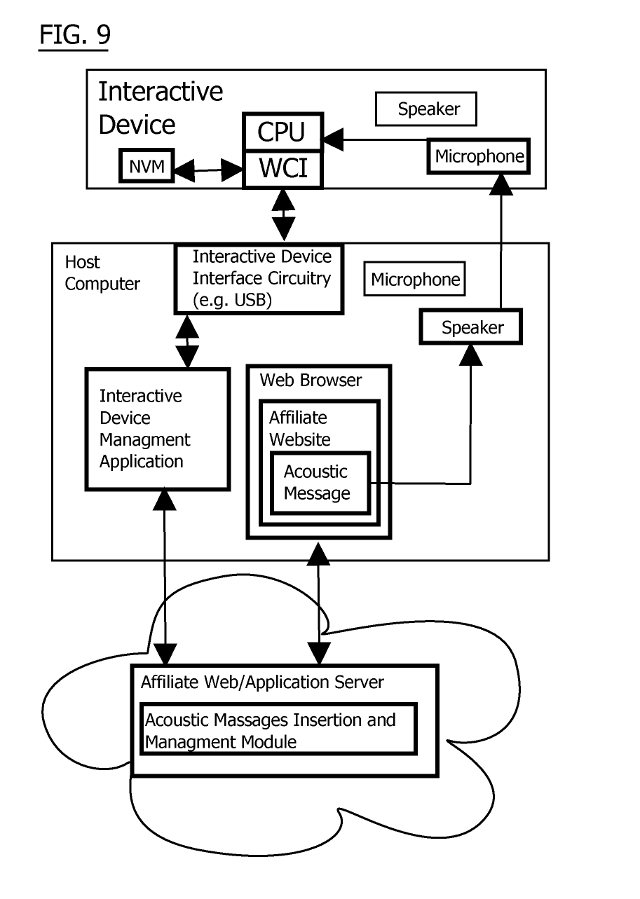

In FIG. 8 there is shown, in accordance with some embodiments of the present invention, an interactive device communicating with a Dedicated Web/Application Server through a host computer, using their acoustic input and output components. Acoustic messages/signals presented by the server on the host computer web browser may be outputted by the host computer's speaker and sensed by the interactive device's microphone. The interactive device may, in response, output acoustic reply messages/signals through its speaker. These reply messages/signals may be sensed by the host computer's microphone and communicated back to the server using the host computer's browser application and/or an Interactive Device Management Application installed on the host computer. In FIG. 9 there is shown, in accordance with some embodiments of the present invention, a configuration wherein an interactive device is adapted to receive and respond to acoustic messages/signals from an Affiliate Web/Application Server. Acoustic messages/signals on the affiliate server may be accessed by a host computer web-browser and outputted by its speaker; the interactive device may sense the signals and accordingly reply to the host computer and/or trigger a device output response.

According to some embodiments of the present invention, different response packages/sets may be downloaded to the interactive device. According to some embodiments, acoustic signals sensed by device, and corresponding commands, may contain a reference to a specific response package. Accordingly, two given, else wise similar, command numbers may each contain a different response package number/code and may thus trigger different responses associated with the specific source and or content from which they originated.

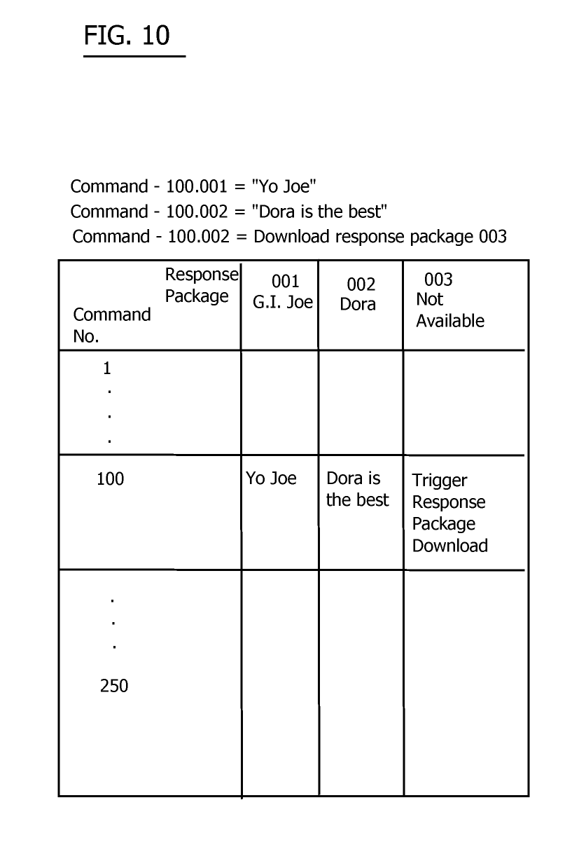

In FIG. 10 there is shown, in accordance with some embodiments of the present invention, a schematic exemplary reference table that may be used to select responses corresponding to different response packages/sets. According to some embodiments, acoustic signal based commands may comprise a command number and a response package number. Accordingly, two else wise similar commands may also include unique response package codes or IDs. When the table is referenced, using the same command number (e.g. 100) which is supposed, for example, to trigger a happy response, the actual happy response is selected based on the command's response package number (e.g. 001, 002, 003). If, for example, response package 001 (e.g. G.I. Joe) is selected the happy response may be ‘Yo Joe’ and if response package 002 (e.g. Dora) is selected the happy response may be ‘Dora is the best’. If a response package 003 is selected and no corresponding response package is available, the interactive device may trigger a download of the missing response package (e.g. through a host computer browser or the host computer's Interactive Device management Application).

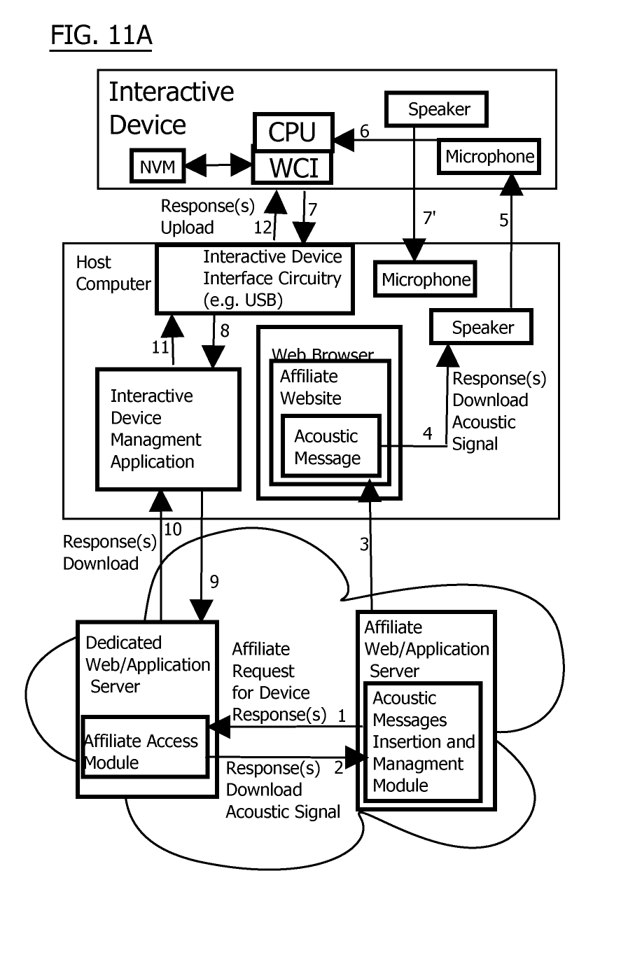

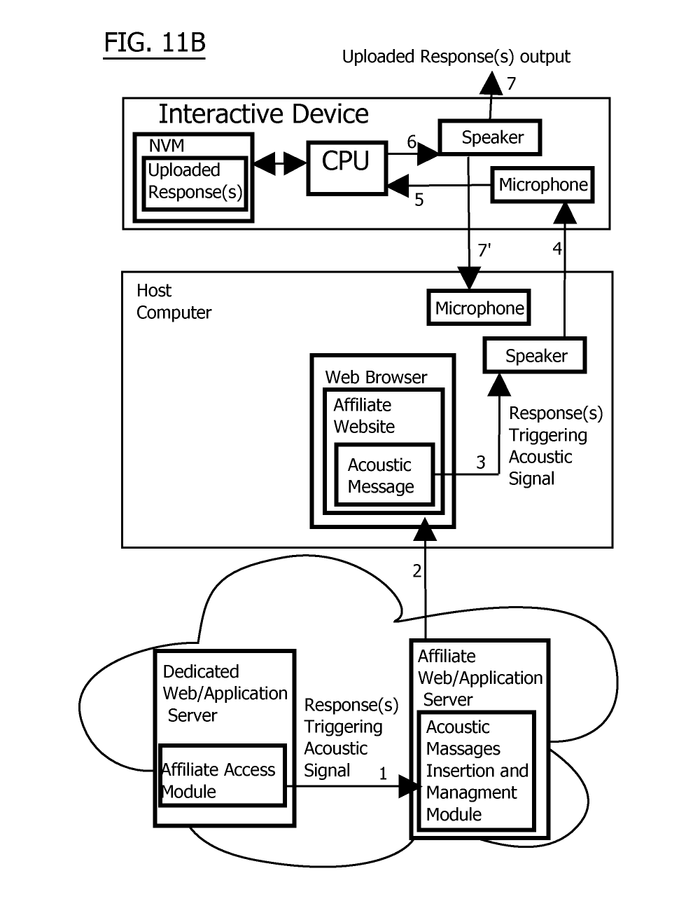

In FIG. 11A there is shown, in accordance with some embodiments of the present invention, a configuration wherein an interactive device is adapted to download an affiliate response package. The download process may comprise some or all of the following steps: (1) An Affiliate Web/Application Server communicates a request for device responses (e.g. a responses containing package) to the Dedicated Web/Application Server through the dedicated server's Affiliate Access/update Module; (2) The dedicated server returns to the affiliate server's Acoustic Messages Insertion and Management Module an acoustic message/signal corresponding to the requested response package, and The affiliate server's Acoustic Messages Insertion and Management Module inserts the acoustic message/signal into one or more contents presented on its website; (3) The acoustic message is presented to the host computer's web browser (e.g. as a flash application); (4) The acoustic message/signal is communicated to the host computer output component (e.g. speaker) leaving a record (e.g. a cookie) containing the response package code, and possibly the registration code(s) of the interactive device(s) to which the package is intended, on the host computer; (5) The host computer speaker outputs the acoustic message/signal which is sensed by the interactive device's input component (e.g. microphone); (6) The sensed signal is processed by the interactive device; (7) The interactive device communicates, through its WCI and/or through its speaker as an acoustic signal, to the host computer the response package code and/or the interactive device's registration code; (8) The host computer installed Interactive Device Management Application (e.g. non-flash client application) either uses the response package code received from the interactive device or uses the interactive device's registration code to access the record (e.g. cookie) left on the host computer and extract the response package code, and (9) communicates the received or extracted response package code to the dedicated server; (10) the response package corresponding to the communicated code is downloaded to the host computer; (11) the host computer's Interactive Device management Application uses the Interactive Device Interface Circuitry to; (12) Upload the new response package to the interactive device, or to one or more specific interactive devices which registration codes are listed on the record (e.g. cookie) left on the host computer, through the interactive device's WCI(s).

According to some embodiments of the present invention, downloads may be to the interactive device may be selective/manual and triggered by the device user (e.g. through the dedicated web/application server's user interface); forced (e.g. upon connection of the device to a host device browsing the dedicated web/application server website; environmental (e.g. triggered by one or more of the interactive device environmental sensors or clock); and/or geographic (e.g. the interactive device connects to the dedicated web/application server from a host computer having a new IP address and regional updates corresponding to the new IP based determined location, such as language of responses, are downloaded).

According to some embodiments of the present invention, different response packages may allow for two or more interactive devices to logically interact in two or more languages. For example, two or more response packages may contain similar responses in different languages. Accordingly, a first interactive device may output a response in English with a corresponding acoustic signal, a second interactive device, adapted to response in Spanish, may correlate the received acoustic signal to a logical matching response in Spanish. The interactive devices may thus be used to communicate between two users speaking different languages and/or as translation tools.

In FIG. 11B there is shown, in accordance with some embodiments of the present invention, a configuration wherein an interactive device is adapted to output a response based on a downloaded affiliate response package. The process may comprise some or all of the following steps: (1) Response Triggering Acoustic Signal(s), corresponding to a certain affiliate's response package(s) is communicated by the dedicated server to the affiliate server; (2) the affiliate server's Acoustic Messages Insertion and Management Module inserts the acoustic message/signal into its website; (3) the acoustic message/signal is triggered through the host computer's web browser and is sent to the host computer's speaker; (4) the host computer speaker outputs the signal which is sensed by the interactive device's microphone; (5) the signal is processed by the interactive device and then correlated to a corresponding command and a previously uploaded response package, and the matching response (e.g. response media file) is read from the device's NVM; (6) the response is transmitted to the interactive device's speaker; and/or (7) the response is outputted by the interactive device's speaker (7′) and is possibly sensed by the host computer's microphone or other interactive device's microphones.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An interactive device comprising:
an acoustic sensor to sense one or more acoustic signals;
a signal recognition circuitry (SRC) to recognize a sensed signal in a signals reference and correlation table, and to correlate recognized signal to one or more corresponding commands; and
a behavior logic module (BLM) to select one or more responses from a command to response correlation logical map, wherein the one or more responses are selected based on the correlated one or more commands and one or more secondary factors.

2. The device according to claim 1 wherein the secondary factor is an outcome of a pseudo random value generator.

3. The device according to claim 1 wherein the secondary factor is a behavior logic state/mode which the BLM is in.

4. The device according to claim 1 wherein the secondary factor is a certain appearance of previously detected commands logged by the BLM.

5. The device according to claim 1 wherein the secondary factor is a choice made by the interactive device user.

6. The device according to claim 1 wherein the secondary factor is one or more temporal characteristics of the correlated commands.

7. The device according to claim 1 wherein the secondary factor is one or more environment related parameters sensed by the interactive device.

8. A system for managing/commanding an interactive device comprising:
a computerized host device comprising an audio output component;
a server networked to said computerized host device adapted to render to a web browser running on said computerized host device content including at least one or more acoustic signals recognizable by the interactive device; and
wherein said computerized host device audio component outputs the one or more acoustic signals recognizable by the interactive device causing the device to execute one or more responses that are based on the recognizable signals and one or more secondary factors.

9. The system according to claim 8 wherein the secondary factor is an outcome of a pseudo random value generator.

10. The system according to claim 8 wherein the secondary factor is a behavior logic state/mode which the device is in.

11. The system according to claim 8 wherein the secondary factor is a certain appearance related to previously detected signal logged by the device.

12. The system according to claim 8 wherein the secondary factor is a choice made by the interactive device user.

13. The system according to claim 8 wherein the secondary factor is one or more temporal characteristics of the recognized signals.

14. The system according to claim 8 wherein the secondary factor is one or more environment related parameters sensed by the interactive device.

15. The system according to claim 8 wherein at least one of the interactive device's responses is an output of an acoustic sound.

16. The system according to claim 8 wherein at least one of the interactive device's responses is a change of a behavior logic state/mode which the interactive device is in.

17. The system according to claim 8 wherein at least one of the interactive device's responses is a download of a responses-package being initiated.

18. The system according to claim 8 wherein at least one of the interactive device's responses turns it into a device dominant to other substantially similar devices in its vicinity.
